(19) United States
(12) Patent Application Publication
(10) Pub. No.: US 2016/0263859 A1
(43) Pub. Date: Sep. 15, 2016

(54) BREATHABLE COMPOSITE FILM

(71) Applicant: INVISTA TECHNOLOGIES S.À R.L., St. Gallen (CH)

(72) Inventors: Sundar Mohan RAO, Chattanooga, TN (US); John Paul RYAN, Newark, DE (US)

(73) Assignee: INVISTA North America S.ar.l., Wilmington, DE (US)

(21) Appl. No.: 15/029,360

(22) PCT Filed: Oct. 14, 2014
(86) PCT No.: PCT/US2014/060404

§ 371 Date: Apr. 14, 2016

Related U.S. Application Data
(60) Provisional application No. 61/890,746, filed on Oct. 14, 2013.

(51) Int. Cl. B32B 7/12; B32B 3/30; B32B 5/18; B32B 5/02; B32B 27/40; B32B 27/08; B32B 27/06; B32B 27/32; B32B 27/28; B32B 27/34; B32B 3/26; B32B 27/12

(52) U.S. Cl. CPC B32B 7/12; B32B 3/266; B32B 3/30; B32B 5/18; B32B 5/022; B32B 27/12; B32B 27/08; B32B 27/065; B32B 27/32; B32B 27/285; B32B 27/34; B32B 27/40; B32B 2266/0278; B32B 2307/724; B32B 2307/7265; B32B 2307/5825; B32B 2471/02

(57) ABSTRACT

A composite film comprising one or more barrier film layers, wherein the one or more barrier film layers are liquid impermeable and have a total moisture vapor transfer rate (MVTR) of at least 14.6 g/24 hr/m² according to ASTM E96B and one or more dimensionally stable layers, wherein the composite film has a robustness of greater than about 1.49 pound force.

### FIELD OF THE INVENTION

This disclosure relates to composite films that are liquid impermeable and moisture vapor permeable.

### BACKGROUND

Films that are liquid impermeable and moisture vapor permeable have many applications. These include use in apparel, upholstery, fabrics and protective layers on flooring and carpet pads. These films are usually made from synthetic polymers such as polyethylene or polypropylene.

Carpets or rugs are typically installed over a carpet pad that includes a resilient cushion material. The purpose of the pad is to make the carpeted flooring surface feel soft and luxurious to those walking on it.

Typically, carpet pads are formed from polymeric materials such as synthetic latex rubber, natural rubber and polyurethane, all of which are distinguished by their ability to deform and recover. One of cheapest and most common materials used for carpet pad is an agglomeration of foam pieces, usually of polyurethane, called rebond.

Most cushion materials used for carpet pads are open structures with an inherent ability to absorb or transmit liquids. As a result, a liquid spilled onto the carpet tends to saturate the carpet pad and pass through the pad to the flooring underneath. In such cases, the liquid is almost impossible to recover completely. Liquid retained in the pad and on the flooring material beneath it may give rise to bacterial growth, causing the pad to emit an unpleasant odor. To avoid damage to the base flooring and to mitigate odor problems it may be necessary to remove and replace the pad.

Moisture retention in the cushion material also presents a problem for moisture passing upwardly from the floor. Most floor surfaces transmit water vapor from locations of higher humidity beneath them, whether from the ground, the basement, or even the room below, and the volume of this moisture is often surprisingly large. It is therefore very important that any water vapor from beneath the floor be able to pass through the carpet pad. That is, the pad should be permeable to moisture vapor. Otherwise, the base flooring may be exposed to condensation moisture, again resulting in mold or bacterial growth and damage.

This ability to transmit water vapor is called “moisture vapor permeability”, or “breathability”, and is measured in terms of moisture vapor transmission rate (MVTR). The Carpet and Rug Institute, Dalton, Ga., recommends an upper limit rate of moisture vapor transmission through a floor to be 14.6 to 24.4 grams per square meter per twenty-four hours (14.6 to 24.4 gms/m²/24 hours) as measured by ASTM test E96B.

To expedite manufacture and to provide a low friction surface that facilitates carpet installation some carpet pads, especially those of rebond, have polymeric films bonded to their upper surface. As long as the film remains intact, it has the tendency to repel liquids. Many important factors affect the application and efficacy of films that are used on carpet pads. These include the moisture vapor transmission rate (MVTR), the thickness of the film and the robustness of the film. The MVTR of the film is needed to ensure that the required amount of vapor is transferred through the carpet pad and not trapped under the film. It is desirable to keep the film as thin as possible to reduce the costs involved. The challenge with using a thin film that is cheaper to make is that it often lacks the robustness necessary to survive use, causing tearing and ineffectiveness.

While most of the carpet pads of the prior art initially have the capability to resist the intrusion of liquid spills, this liquid impermeability usually fails due to forces imposed during spot cleaning or after normal traffic. Some pads of the prior art, particularly those of closed cell foams or those having thick film layers, can resist liquid spills made on carpets above them, and can do so even during spot cleaning or after a reasonable level of foot traffic. However, these structures are not moisture vapor transmissive and thus they fail to achieve the desirable level of moisture vapor permeability.

U.S. Pat. No. 6,253,526 discloses a process for installation of carpet in which the critical properties of breathability and water impermeability are resident in an underlayment that is separate from the padding. While the underlayment is effective in achieving both desired moisture vapor permeability and resistance to spills it requires a separate installation step which is not cost effective and is therefore not widely used.

WO Publication 01/27382 A1 describes an underlayment for a carpet having the desired properties of moisture vapor permeability, liquid impermeability and durability that is maintained under the pressure of cleaning and that would be tolerant of normal foot traffic on the carpet above. However, the structure of this underlayment uses a laminated substrate of fibrous material, which significantly adds to its cost.

U.S. Pat. No. 5,531,849 discloses a pad having a smooth polyurethane foam layer disposed between two film layers. Canadian Patent 2,320,471 describes an underlayment with a liquid impervious film formed over containment channels to hold spills near the point of introduction and make them easier to recover. However, these pads are not breathable and the durability of both of these pad structures and the ability to retain liquid imperviousness is highly dependent on the thickness of the film layer employed.

U.S. Pat. No. 6,872,445, herein incorporated in its entirety, teaches a carpet pad that utilizes a synthetic polymeric material directly bonded to the upper surface of the cushion that is simultaneously impermeable to liquid deposited onto the pad from above the barrier film, and permeable to moisture vapor at a MVTR of at least 14.6 g/m²/24 hr. In order to have the required robustness for practical use, a film of thickness of at least 0.5 mils, but usually much greater, must be used. Because these breathable films are expensive, this adds to carpet pad costs.

U.S. Pat. No. 8,283, 029 teaches composite films comprising multiple layers of barrier film layers. The films of this disclosure do not feature the robustness necessary for applications such use with carpet pads and often require the use of a nonwoven layer.

Therefore there is a need for a film that can be used for many applications, including use with carpet pads that have desired liquid impermeability, moisture vapor transmission rates, robustness necessary to survive regular use and wear, and can be made and installed in a cost effective fashion.

### SUMMARY OF THE INVENTION

The present disclosure relates to composite films of at least two film layers wherein at least one film layer is a barrier layer which is liquid impermeable and moisture vapor permeable.

One aspect of the present invention relates to a composite film comprising:
a) one or more barrier film layers, wherein the one or more barrier film layers are liquid impermeable and have a total moisture vapor transfer rate (MVTR) of at least 14.6 g/24 hr/m² according to ASTM E96B; and
b) one or more dimensionally stable layers, wherein the composite film has a robustness of greater than about 1.49 pound force.

In one nonlimiting embodiment, the total thickness of the one or more barrier layers is less than about 0.5 mils.

In another nonlimiting embodiment, the total thickness of the composite film is less than about 2.0 mils.

In another nonlimiting embodiment, the composite film has a robustness of greater than about 2 pound force.

In another nonlimiting embodiment, the composite film has a robustness of about 2.33 pound force.

In one nonlimiting embodiment, the composite film has an MVTR greater than about 50 grams/24 hr/m², a thickness of less than about 4.5 mils and a robustness of greater than about 2 pound force.

In another nonlimiting embodiment, the composite film has a MVTR in the range from about 50 to about 4500 grams/24 hr/m² according to ASTM E96B.

In another nonlimiting embodiment, the one or more dimensionally stabilizing layers is selected from the list consisting of polyolefins, poly(ether-b-amide)s, polyesters, polyurethanes and copolymers and blends thereof.

In another nonlimiting embodiment, each of the one or more dimensionally stabilizing layers is a heat activated adhesive layer.

In another nonlimiting embodiment, each of the one or more dimensionally stabilizing layers is a calendared layer.

In another nonlimiting embodiment, the one or more of the dimensionally stabilizing layers are apertured layers having holes at a rate of about 5,000 to about 50,000 holes per square meter.

In another nonlimiting embodiment, the apertured layers have holes at a rate of about 20,000 to about 50,000 holes/m².

In another nonlimiting embodiment, the apertured layers have holes having diameters from about 1 to about 100 microns in length.

In another nonlimiting embodiment, the apertured layers have holes having diameters from about 5 to about 25 microns in length.

Another aspect of the present invention relates to a carpet pad comprising:
a) a carpet cushion having an upper and lower surface thereon, and
b) a composite film bonded to said upper surface comprising one or more barrier layers and one or more dimensionally stabilizing layers, wherein the composite film has a moisture vapor transmission rate (MVTR) of at least 14.6 g/24 hr/m² according to ASTM E96B and a robustness of greater than about 1.49 pound force.

Another aspect of the present invention relates to a carpet system comprising a carpet pad comprising
a) a carpet cushion having an upper and lower surface thereon;
b) a composite film bonded to said upper surface comprising one or more barrier layers and one or more dimensionally stabilizing layers; and
c) a carpet laid adjacent to said upper surface of said pad, said carpet comprising a plurality of tufted yarns, a primary backing for receiving said tufted yarns, and a secondary backing, wherein the composite film has a moisture vapor transmission rate (MVTR) of at least 14.6 g/24 hr/m² according to ASTM E96B and a robustness of greater than about 1.49 pound force.

Yet another aspect of the present invention relates to a method of making a carpet pad comprising a) providing a carpet cushion having an upper and lower surface thereon, b) providing a composite film comprising one or more barrier layers and one or more dimensionally stabilizing layers, wherein the composite film achieves a moisture vapor transmission rate (MVTR) according to ASTM E96B of from about 50 to about 4500 grams/24 hr/m², prior to bonding said composite film to said upper surface of said carpet cushion, and c) physically bonding said composite film to said upper surface of said carpet cushion.

### DETAILED DESCRIPTION OF THE INVENTION

Provided by this disclosure is a composite film that can be used to impart liquid impermeability and moisture vapor permeability on a substrate. The composite films of the current disclosure comprise of one or more moisture vapor permeable barrier layer films that have the required moisture vapor transmission rate for industrial use. In addition the composite films of the current disclosure also comprise one or more dimensionally stabilizing layers. The composite films of the current disclosure have moisture vapor transmission rate (MVTR) of at least about 14.6 g/24 hr/m² according to ASTM E96B, a robustness of greater than about 1.49 pound force and can be used in many applications including, but not limited to apparel, upholstery, carpet pads, flooring, coverings, packaging, containers, insulations, medical and hygienic products, moisture proofing, roofing, building materials, etc. Also provided by this disclosure are carpet pads and carpet systems that comprise the composite films.

The composite film of the present disclosure provide the structural integrity and the opportunity to customize features such as MVTR, robustness and thickness based on a desired application. The composite films may also have antimicrobial or odor reducing chemistries built in.

Definitions

The term “barrier layer”, as used herein, is meant to include a material that is liquid impervious, but also water vapor permeable.

The term “dimensionally stabilizing” layer, as used herein, is meant to include a material which provides integrity to the barrier layer. This includes, but is not limited to, materials that provide support, prevent tearing, and maintain the barrier structure of the barrier layer. The durable, dimensionally stabilizing layer may or may not include barrier properties. The durable, dimensionally stabilizing layer may include any suitable form such as a film, a nonwoven web, or an adhesive. In one aspect, the durable dimensionally stabilizing layer is discontinuous and does not prevent the desired function of the barrier layer.

The term “robustness”, as used herein, refers to the tear strength, as measure by pound force, necessary to tear a film. The robustness refers to the durability, strength and resilience of the film. Robustness is an important parameter to determine if a film will be able to sustain continued use or wear. This is particularly important in film applications such as on a flooring system or carpet pad that will be incur repeated applications of force over time. The robustness of the samples tested in the Examples was established by testing a 3 inch sample length on an Instrom model 33R4204.

In nonlimiting embodiments of the present invention, the composite film comprises one or more barrier film layers and one or more dimensionally stable layers. The one or more barrier film layers are liquid impermeable and have a total moisture vapor transfer rate (MVTR) of at least 14.6 g/24 hr/m² according to ASTM E96B and the composite film has a robustness of greater than about 1.49 pound force.

In nonlimiting embodiments of the present invention the one or more barrier film layers are selected from the list consisting of polyolefins, ethylene vinyl acetate polymers, ethylene ethyl acrylate polymers, ethylene acrylic acid polymers, ethylene methyl acrylate polymers, ethylene butyl acrylate polymers, polyesters, polyamides, ethylene vinyl alcohol polymers, polystyrenes, polyurethanes, polyetherolefinic thermoplastic elastomers of ethylene and propylene, poly-ether-amides block copolymers, polyethylene-acrylic acid copolymers, polyethylene oxide and its copolymers, poly lactide and copolymers, polyamides, polyester block copolymers, sulfonated polyesters, poly-ether-ester block copolymers, poly-ether-ester-amide block copolymers, polyacrylates, polyacrylic acids, ionomers, polyethylene-vinyl acetate with a vinyl acetate content of more than 28 weight %, polyvinyl alcohol and its copolymers, polyvinyl ethers and their copolymers, poly-2-ethyl-oxazoline, polyvinyl pyrrolidone and its copolymers, and combinations thereof.

In nonlimiting embodiments of the present invention, each of the one or more barrier film layers comprise a monolithic film, a microporous film or a combination thereof.

Barrier layers of any thickness may be used that have a MVTR of at least 14.6 g/24 hr/m². In nonlimiting embodiments of the present invention, the total thickness of the one or more barrier layers range from about 0.25 mils to about 2.0 mils. In nonlimiting embodiments of the present invention, the total thickness of the one or more barrier layers is less than about 0.5 mils. In nonlimiting embodiments, the one or more barrier film layers may impart an MVTR in the range from about 50 to about 4500 g/24 hr/m² to the composite film.

Dimensionally stabilizing layers of any thickness may be used to impart the necessary robustness to the composite film. In nonlimiting embodiments of the present invention, the total thickness of the one or more dimensionally stabilizing layers range from about 0.5 mils to about 2.5 mils.

In nonlimiting embodiments, the total thickness of the composite film may range from about 0.75 to 7.0 mils. In one nonlimiting embodiment of the present invention, the total thickness of the composite film is less than about 2.0 mils.

The composite film of the present disclosure may comprise any number of barrier film layers or dimensionally stabilizing layers, so that the robustness of the composite film is at least about 1.49 pound force. In nonlimiting embodiments, the composite film has a robustness of greater than about 2 pound force. In one nonlimiting embodiment, the composite film has a robustness of about 2.33 pound force.

In one nonlimiting embodiment, the composite film has an MVTR greater than about 50 grams/24 hr/m², a thickness of less than about 4.5 mils and a robustness of greater than about 2 pound force.

In nonlimiting embodiments, the one or more dimensionally stabilizing layers is selected from the list consisting of polyolefins, poly(ether-b-amide)s, polyesters, polyurethanes and copolymers and blends thereof. In nonlimiting embodiments, each of the one or more dimensionally stabilizing layers is a heat activated adhesive layer. In nonlimiting embodiments, each of the one or more dimensionally stabilizing layers is a calendared layer.

The dimensionally stabilizing layers of the present disclosure are perforated so that they are both liquid and moisture permeable. In nonlimiting embodiments, the one or more of the dimensionally stabilizing layers are apertured layers having holes at a rate of about 5,000 to about 50,000 holes per square meter. In nonlimiting embodiments, the apertured layers have holes at a rate of about 20,000 to about 50,000 holes/m2. In nonlimiting embodiments, the apertured layers have holes having diameters from about 1 to about 100 microns in length. In nonlimiting embodiments, the apertured layers have holes having diameters from about 5 to about 25 microns in length.

The present disclosure also discloses a carpet pad comprising the composite film described herein. In nonlimiting embodiments, the carpet pad comprises a carpet cushion having an upper and lower surface thereon, and a composite film bonded to said upper surface comprising one or more barrier layers and one or more dimensionally stabilizing layers, wherein the composite film has a MVTR of at least 14.6 g/24 hr/m² according to ASTM E96B and a robustness of greater than about 1.49 pound force. In nonlimiting embodiments, the carpet cushion may be selected from the group consisting of continuous or rebond foam. In nonlimiting embodiments, the carpet cushion is selected from the group consisting of polyurethane, jute, cotton, rubber, and rebond polyurethane.

In order to effective for use with carpet pads, a film must have the robustness to undergo the lamination process. The lamination process to make such a composite of films is well known and practiced. This carpet pads comprising the composite film of present disclosure provide a cost effective way to make and use barrier layer films that are liquid impenetrable but allow moisture vapor to pass through while also maintaining the robustness needed to enable lamination of the composite film on carpet cushion.

Any configuration of the one or more barrier layer films and dimensionally stabilizing layers may be used in a carpet pad construction. In one nonlimiting embodiment, a single barrier layer and a single dimensionally stabilizing layer may be used. The dimensionally stabilizing layer may be lactated above or below the barrier film layer.

In nonlimiting embodiments, two dimensionally stabilizing layers may be used with a single barrier film layer on a carpet pad. In nonlimiting embodiments, the dimensionally stabilizing layers may also have antimicrobial or odor reducing chemistries incorporated. In nonlimiting embodiments, the dimensionally stabilizing layers may also feature a logo or product identifier. In one nonlimiting embodiment the single barrier layer is located in between the two dimensionally stabilizing layers to form a “sandwich” configuration.

The sandwich configuration described has several advantages. The dimensionally stabilizing layer above the barrier film layer will be in contact with carpet backing, which is typically a rough surface. The dimensionally stabilizing layer will provide the robustness necessary to protect the barrier film layer form being damaged. Similarly, the dimensionally stabilizing layer below the barrier layer film will be in contact with the carpet cushion. It is common for the carpet cushion to me constructed from rebond (recycled foam) that has hard particles or has potential to create puncture holes into the barrier layer film. The dimensionally stabilizing layer located between the carpet cushion and the barrier layer film will provide the robustness necessary to protect the barrier film layer form being damaged.

The present disclosure also discloses a carpet system comprising the composite films described herein. In nonlimiting embodiments, a carpet system comprises a carpet pad comprising a carpet cushion having an upper and lower surface thereon, a composite film bonded to said upper surface comprising one or more barrier layers and one or more dimensionally stabilizing layers and a carpet laid adjacent to said upper surface of said pad, said carpet comprising a plurality of tufted yarns, a primary backing for receiving said tufted yarns, and a secondary backing, wherein the composite film has a moisture vapor transmission rate (MVTR) of at least 14.6 grams per square meter per twenty-four hours (14.6 g/24 hr/m2) according to ASTM E96B and a robustness of greater than about 1.49 pound force.

In nonlimiting embodiments, the carpet system comprises tufted yarns that are selected from the group consisting of polyamide, polyester, polypropylene, acrylic, wool, blended yarns and combinations thereof. In nonlimiting embodiments, the total thickness of the one or more barrier layers is less than about 0.5 mils. In nonlimiting embodiments, the total thickness of the composite film is less than about 2.0 mils. In nonlimiting embodiments, the composite film has a robustness of greater than about 2 pound force. In one nonlimiting embodiments, the composite film has a robustness of about 2.33 pound force.

### EXAMPLES

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and non-limiting.

### TEST METHODS

Liquid Penetration Test Method. Cherry flavored Kool-Aid (20 mL) was applied on top of a carpet cushion substrate, and the treated substrate was allowed to stand for 24 hours. An observation was then made on whether the color had penetrated through the cushion to the other side and to determine if the film had the necessary liquid impermeability.

Moisture Vapor Transmission Rate Test Method. MVTR was determined according to the method provided by the American Society for Testing and Materials, Method E96 B, at 50% +/−3% RH, at 23° C.

### EXAMPLES

### Comparative Examples 1-10

Breathable films were obtained and tested for MVTR. In some testing, the films were also assembled onto carpet cushion. The carpet cushion was a polyurethane rebond cushion supplied by Leggett & Platt, Inc. (Villa Rica, Ga., USA). The results are described below, and summarized in Table 1.

For Examples 1 and 2, INTEGRAL D200 was obtained and tested for MVTR as a standalone film (Example 1), and as assembled onto rebond cushion (Example 2). INTEGRAL D200 is a heat-activated polyolefin adhesive film provided by Dow Chemical Co. (Midland, Mich., USA). This film has typical thickness of 45-65 μm and a heat activation point of 96° C. (205° F.). Dow 200 film is robust, but it does not permit any moisture vapor transmission—the materials in Example 1 and 2 were found to have MVTR=0 g/m²/24 h.

For Examples 3 and 4, PO 06006 was obtained and tested for MVTR as a film on non-woven backing (Example 3), and as an assembly on rebond cushion (Example 4). PO 06006 is a polyolefin resin provided by Clopay Plastic Products Co. (Mason, Ohio, USA). PO 06006 has a basis weight of 30 gsm, but is so thin that it cannot be used as a single film on top of carpet cushion. PO 06006 was tested on non-woven backing. However, while non-woven backing improves robustness, it is expensive. This substrate was tested for MVTR and found to give MVTR=460 g/m²/24 (Example 3) and MVTR=411 g/m²/24 h (Example 4).

Examples 5 and 6 were prepared as a blend of two polymer resin types—Pebax® MV 1074 and Lotryl® 28 MA 07. Pebax® MV 1074 is a thermoplastic polyether block amide resin provided by ARKEMA (Colombes, France). Lotryl® 28 MA 07 is a random copolymer of ethylene and 26-30 wt % methyl acrylate, provided by ARKEMA (Colombes, France). A 2:3 w:w film was made of Pebax® MV 1074 and Lotryl® 28 MA 07 on non-woven backing, and the composite structure was found to give MVTR=658 g/m²/24 h (Example 5). However, while non-woven backing improved the robustness of the thin film, non-woven backing is expensive. When assembled onto rebond carpet cushion, the substrate was tested and MVTR=510 g/m²/24 h was determined (Example 6).

For Examples 7 and 8, Pebax® MV 1075 was obtained and tested for MVTR as a standalone film (Example 7), and as assembled onto rebond cushion (Example 8). Pebax® MV 1075 is a thermoplastic polyether block amide resin provided by ARKEMA (Colombes, France. This film has typical thickness of 25 μm. The materials in Example 7 and 8 were found to have MVTR=889 g/m²/24 h and 560 g/m²/24 h, respectively.

For Examples 9 and 10, Pebax® MV 3000 was obtained and tested for MVTR as a standalone film (Example 9), and as assembled onto rebond cushion (Example 10). Pebax® MV 3000 is a thermoplastic polyether block amide resin provided by ARKEMA (Colombes, France. This film has typical thickness of 20 μm. The materials in Example 9 and 10 were found to have MVTR=642 g/m²/24 h and 543 g/m²/24 h, respectively.

For Examples 11 and 12, Pebax® MV 3000 was obtained and tested for MVTR as a standalone film (Example 9), and as assembled onto rebond cushion (Example 10). Pebax® MV 3000 is a thermoplastic polyether block amide resin provided by ARKEMA (Colombes, France. This film has typical thickness of 11 μm. The materials in Example 11 and 12 were found to have MVTR=790 g/m²/24 h and 527 g/m²/24 h, respectively.

Many of the films in Comparative Examples 1-12 have good MVTR, but suffer from poor roubustness and are not suitable for processes to assemble onto carpet cushion, such as lamination. The replacement of a non-woven structure with robust apertured films as described in Examples 13, 14 and 15 produces composite structures that are suitable for cushion assemblies, and that meet or exceed the MVTR suitable for those commercial applications.

TABLE 1

| Example | | Backing | Cushion | MVTR |
|---|---|---|---|---|
| no. | Film description | type | type | (g/m²/24 h) |
| 1 | INTEGRAL ™ D200 | none | none | 0 |
| 2 | INTEGRAL ™ D200 | none | rebond | 0 |
| 3 | Clopay PO 06006 | non- | none | 460 |
| | BR128 | woven | | |
| 4 | Clopay PO 06006 | non- | rebond | 411 |
| | BR128 30GSM | woven | | |
| 5 | 60% Pebax MV 1074 | non- | none | 658 |
| | 40% Lotryl 28 MA 07 | woven | | |
| 6 | 60% Pebax MV 1074 | non- | rebond | 510 |
| | 40% Lotryl 28 MA 07 | woven | | |
| 7 | Pebax MV 1075 | none | none | 889 |
| 8 | Pebax MV 1075 | none | rebond | 560 |
| 9 | Pebax MV 3000 20 μm | none | none | 642 |
| 10 | Pebax MV 3000 20 μm | none | rebond | 543 |
| 11 | Pebax MV 3000 11 μm | none | none | 790 |
| 12 | Pebax MV 3000 11 μm | none | rebond | 527 |

### Example 13

Polyurethane film PT1001, made by American Polyfilm Inc. (Branford, Conn., USA), was covered on one side by perforated film PT02 (basis weight 22 g/m²) made Clopay Plastic Products Co. (Mason, Ohio, USA), and assembled on rebond carpet cushion made by Leggett and Platt. This assembly had MVTR of 230 gm/m²/24 h. While this is a good MVTR, the perforated film did not have the robustness to be used in cushion laminating process.

### Example 14

Polyurethane film PT1001, made by American Polyfilm Inc. (Branford, Conn., USA), was covered on both sides by perforated film PTA (24 g/m²) made by Clopay Plastic Products Co. (Mason, Ohio, USA), and assembled on rebond carpet cushion made by Leggett and Platt. This assembly had MVTR of 296 g/m²/24 h. While this is a good MVTR, the perforated film did not have the robustness to be used in cushion laminating process.

### Example 15

Polyurethane film PT1001, made by American Polyfilm Inc. (Branford, Conn., USA), was covered on both sides by perforated film QE904CLN (1.8 mil thick) made by Bloomer Plastics (Bloomer, Wis., USA) and assembled on rebond carpet cushion made by Leggett and Platt. This assembly had MVTR of 50 g/m²/24 h, which is an acceptable MVTR for a carpet pad. The perforated film QE904CLN has also been found to have effective robustness.

The robustness of the composite film described in Example 15 was established by testing a 3 inch sample length on an Instron (Model 33R4204). The tear strength needed to tear the sample was 2.33 lbf. In comparison, the Hytrel® barrier film tested under the same conditions, required a pound force of 1.49 lbf. Since Hytrel® film is used as cushion barrier film in the industry currently, the robustness of the composite film of Example 15 is well established.

Therefore, the composite film described in Example 15 is robust as well as provides acceptable MVTR. Such a composite structure could use very thin barrier films with high MVTR and also ensure there is no liquid penetration as the barrier film is impenetrable. The structure can be optimized for cost, MVTR, robustness and penetration by liquids. An adhesive layer can be additionally added to ensure good bonding between this composite structure and cushion.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±8%, or ±10%, of the numerical value(s) being modified. In addition, the phrase “about ‘x’ to ‘y’” includes “about ‘x’ to about ‘y’”.

While the illustrative embodiments of the invention have been described with particularity, it will be understood that the invention is capable of other and different embodiments and that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present disclosure, including all features which would be treated as equivalents thereof by those skilled in the art to which the invention pertains.

What is claimed is:

1. A composite film comprising:
a) one or more barrier film layers, wherein the one or more barrier film layers are liquid impermeable and have a total moisture vapor transfer rate (MVTR) of at least 14.6 g/m^{2/}24 hr according to ASTM E96B; and
b) one or more dimensionally stable layers, wherein the composite film has a robustness of greater than about 1.49 pound force.

2. The composite film of claim 1 wherein the one or more barrier film layers are selected from the list consisting of polyolefins, ethylene vinyl acetate polymers, ethylene ethyl acrylate polymers, ethylene acrylic acid polymers, ethylene methyl acrylate polymers, ethylene butyl acrylate polymers, polyesters, polyamides, ethylene vinyl alcohol polymers, polystyrenes, polyurethanes, polyetherolefinic thermoplastic elastomers of ethylene and propylene, poly-ether-amides block copolymers, polyethylene-acrylic acid copolymers, polyethylene oxide and its copolymers, poly lactide and copolymers, polyamides, polyester block copolymers, sulfonated polyesters, poly-ether-ester block copolymers, poly-ether-ester-amide block copolymers, polyacrylates, polyacrylic acids, ionomers, polyethylene-vinyl acetate with a vinyl acetate content of more than 28 weight %, polyvinyl alcohol and its copolymers, polyvinyl ethers and their copolymers, poly-2-ethyl-oxazoline, polyvinyl pyrrolidone and its copolymers, and combinations thereof.

3. The composite film of claim 1 wherein each of the one or more barrier layers comprise a monolithic film, a microporous film or a combination thereof.

4. The composite film of claim 1 wherein the total thickness of the one or more barrier layers is less than about 0.5 mils.

5. The composite film of claim 1 wherein the total thickness of the composite film is less than about 2.0 mils.

6. The composite film of claim 1 wherein the composite film has a robustness of greater than about 2 pound force.

7. The composite film of claim 1 wherein the composite film has a robustness of about 2.33 pound force.

8. The composite film of claim 1 wherein the composite film has a MVTR in the range from about 50 to about 4500 grams/24 hr/m² according to ASTM E96B.

9. The composite film of claim 1 wherein the one or more dimensionally stabilizing layers is selected from the list consisting of polyolefins, poly(ether-b-amide)s, polyesters, polyurethanes and copolymers and blends thereof.

10. The composite film of claim 1 wherein each of the one or more dimensionally stabilizing layers is a heat activated adhesive layer.

11. The composite film of claim 1 wherein each of the one or more dimensionally stabilizing layers is a calendared layer.

12. The composite film of claim 1 wherein the one or more of the dimensionally stabilizing layers are apertured layers having holes at a rate of about 5,000 to about 50,000 holes per square meter.

13. The composite film of claim 12 wherein said apertured layers have holes at a rate of about 20,000 to about 50,000 holes/m².

14. The composite film of claim 12 wherein said apertured layers have holes having diameters from about 1 to about 100 microns in length.

15. The composite film of claim 12 wherein said apertured layers have holes having diameters from about 5 to about 25 microns in length.

16. A carpet pad comprising the composite film of any of claims 1-15.

17. A carpet pad comprising:
a) a carpet cushion having an upper and lower surface thereon, and
b) a composite film bonded to said upper surface comprising one or more barrier layers and one or more dimensionally stabilizing layers, wherein the composite film has a moisture vapor transmission rate (MVTR) of at least 14.6 g/24 hr/m² according to ASTM E96B and a robustness of greater than about 1.49 pound force.

18. The carpet pad of claim 17 wherein the carpet cushion is selected from the group consisting of continuous or rebond foam.

19. The carpet pad of claim 17 wherein the carpet cushion is selected from the group consisting of polyurethane, jute, cotton, rubber, and re-bond polyurethane.

20. The carpet pad of claim 17 wherein the total thickness of the one or more barrier layers is less than about 0.5 mils.

21. The carpet pad of claim 17 wherein the total thickness of the composite film is less than about 2.0 mils.

22. The carpet pad of claim 17 wherein the composite film has a robustness of greater than about 2 pound force.

23. The carpet pad of claim 17 wherein the composite film has a robustness of about 2.33 pound force.

24. A carpet system comprising a carpet pad comprising
a) a carpet cushion having an upper and lower surface thereon;
b) a composite film bonded to said upper surface comprising one or more barrier layers and one or more dimensionally stabilizing layers; and
c) a carpet laid adjacent to said upper surface of said pad, said carpet comprising a plurality of tufted yarns, a primary backing for receiving said tufted yarns, and a secondary backing, wherein the composite film has a moisture vapor transmission rate (MVTR) of at least 14.6 g/24 hr/m² according to ASTM E96B and a robustness of greater than about 1.49 pound force.

25. The carpet system of claim 24 wherein said tufted yarns are selected from the group consisting of polyamide, polyester, polypropylene, acrylic, wool, blended yarns and combinations thereof.

26. The carpet system of claim 24 wherein the total thickness of the one or more barrier layers is less than about 0.5 mils.

27. The carpet system of claim 24 wherein the total thickness of the composite film is less than about 2.0 mils.

28. The carpet system of claim 24 wherein the composite film has a robustness of greater than about 2 pound force.

29. The carpet system of claim 24 wherein the composite film has a robustness of about 2.33 pound force.
